(19) United States
(12) Patent Application Publication
(10) Pub. No.: US 2018/0143890 A1
(43) Pub. Date: May 24, 2018

(54) SIMULATION APPARATUS, SIMULATION METHOD, AND COMPUTER READABLE MEDIUM

(71) Applicant: MITSUBISHI ELECTRIC CORPORATION, Tokyo (JP)

(72) Inventors: Daisuke OGAWA, Tokyo (JP); Osamu TOYAMA, Tokyo (JP); Koji NISHIKAWA, Tokyo (JP)

(73) Assignee: MITSUBISHI ELECTRIC CORPORATION, Tokyo (JP)

(21) Appl. No.: 15/564,343

(22) PCT Filed: May 26, 2015
(86) PCT No.: PCT/JP2015/064995

§ 371 Date: Oct. 4, 2017

(51) Int. Cl. G06F 11/34; G06F 12/0802; G06F 8/41; G06F 9/455

(52) U.S. Cl. CPC G06F 11/3457; G06F 9/455; G06F 8/4441; G06F 12/0802

(57) ABSTRACT

In a simulation apparatus, an execution unit sequentially loads host codes stored in a buffer. The execution unit executes an instruction of each loaded host code. The execution unit also determines whether a corresponding code being a target code corresponding to each loaded host code is included in a tag table. When the execution unit determines that the corresponding code is not included in the tag table, the execution unit simulates an operation for a cache miss situation with respect to the corresponding code. The execution unit updates the tag table according to the simulated operation.

### TECHNICAL FIELD

The present invention relates to a simulation apparatus, a simulation method, and a simulation program.

### BACKGROUND ART

Generally, a cache is mounted in a system constituted from hardware including a central processing unit (CPU) and a memory and software that runs on the hardware in order to transfer data to be frequently read and written between the CPU and the memory at high speed. The memory includes an instruction memory to store an instruction and a data memory to store data. The cache includes an instruction cache memory for storing an instruction and a data cache memory for storing data.

For system development and verification, there is provided a simulation apparatus to perform the verification by operating a hardware model of a target system that is a system to be verified and software of the target system in parallel. The hardware model of the target system is the one in which hardware of the target system is described in a system level design language of a C-based language. The software of the target system is constituted from target codes to be executed by a target processor that is a CPU of the target system. The simulation apparatus simulates execution of each target code by an instruction set simulator (ISS), thereby verifying the target system. The ISS converts each target code to a host code which can be executed by a host CPU that is the CPU of the simulation apparatus, and executes the host code, thereby simulating the execution of the target code. An instruction cache memory for storing the host code that has been recently executed is provided at the ISS in order to execute the host code at high speed.

There is a technology for generating a software verification model in order to execute co-verification of hardware and software of a target system by using a host CPU including an instruction cache memory (see, for example, Patent Literature 1). In this technology, a program described in the C-based language is divided by a branch or jump instruction. A call for a procedure of determining whether or not the instruction cache memory is hit is inserted into the program, for each Basic Block that is a group of instructions obtained by the division. The program after the insertion of the call is executed by an ISS. With this arrangement, it is determined whether or not the instruction cache memory is hit each time the Basic Block is executed. When it is detected that the instruction cache memory is not hit, an execution time for executing a cache line fill is added.

### CITATION LIST

### Patent Literature

Patent Literature 1: JP 2006-23852 A

### SUMMARY OF INVENTION

### Technical Problem

In the conventional technology, it is determined whether or not the instruction cache memory of the host CPU is hit. Therefore, when the size of an instruction cache memory of a target CPU and the size of the instruction cache memory of the host CPU are different, it may be determined that the instruction cache memory of the host CPU is hit even in a situation where the instruction cache memory of the target CPU is not hit. Accordingly, accuracy of estimation of the execution time is not sufficient, so that it is difficult to perform accurate software performance evaluation.

In the conventional technology, when it is detected that the instruction cache memory is not hit, a bus access operation to an instruction memory is not simulated. Accordingly, it becomes more and more difficult to perform the accurate software performance evaluation.

In the conventional technology, a unit of determination whether or not the instruction cache memory is hit is the Basic Block, which does not match a cache line size. Accordingly, accuracy of the determination is also reduced, so that it becomes further difficult to perform the accurate software performance evaluation.

In the conventional technology, the call for the procedure of determining whether or not the instruction cache memory is hit is inserted into the program to be verified, thereby generating the software verification model. That is, the software verification model is a program that has been specially modified. Thus, the software verification model cannot be used for debugging the software.

An object of the present invention is to improve accuracy of cache miss determination at a time of simulation.

### Solution to Problem

A simulation apparatus according to one aspect of the present invention is a simulation apparatus to simulate an operation of a system including a memory to store target codes representing instructions and a cache for storing one or more of the target codes that are loaded from the memory. The simulation apparatus may include:

a storage medium to store a list of a target code to be stored in the cache when an operation for a cache miss situation is assumed to be performed by the system, the operation for a cache miss situation being an operation where the target code stored in the memory is loaded and the cache is updated by the loaded target code;

a buffer for storing host codes representing instructions of corresponding target codes in a format for simulation; and

an execution unit to sequentially load the host codes stored in the buffer, to execute an instruction of each loaded host code and determine whether a corresponding code being a target code corresponding to each loaded host code is included in the list, and, when determining that the corresponding code is not included in the list, to simulate the operation for a cache miss situation with respect to the corresponding code and update the list according to the simulated operation.

### Advantageous Effects of Invention

In the present invention, presence or absence of a cache miss is not determined by using the buffer for storing the host codes. The list of the target code to be stored in the cache is managed and presence or absence of the cache miss is determined by using this list. Thus, according to the present invention, accuracy of cache miss determination is improved.

### BRIEF DESCRIPTION OF DRAWINGS

FIG. 1 is a block diagram illustrating a configuration of a simulation apparatus according to a first embodiment.

FIG. 2 is a block diagram illustrating a configuration of a CPU core model unit of the simulation apparatus according to the first embodiment.

FIG. 3 is a flowchart illustrating operations of the simulation apparatus according to the first embodiment.

FIG. 4 is a flowchart illustrating details of an operation of generating and storing a host code after the simulation apparatus according to the first embodiment adds a determination code.

FIG. 5 is a diagram illustrating an operation of determining a cache hit/miss by the simulation apparatus according to the first embodiment.

FIG. 6 is a flowchart illustrating details of the operation of determining the cache hit/miss by the simulation apparatus according to the first embodiment.

FIG. 7 is a flowchart illustrating details of an operation to be performed according to a result of the determination of the cache hit/miss by the simulation apparatus according to the first embodiment.

FIG. 8 is a diagram illustrating an example of simulation by the simulation apparatus according to the first embodiment.

FIG. 9 is a block diagram illustrating a configuration of a simulation apparatus according to a second embodiment.

FIG. 10 is a block diagram illustrating a configuration of a CPU core model unit of the simulation apparatus according to the second embodiment.

FIG. 11 is a flowchart illustrating operations of the simulation apparatus according to the second embodiment.

FIG. 12 is a flowchart illustrating details of an operation of generating and storing a host code after the simulation apparatus according to the second embodiment adds a determination code.

FIG. 13 is a block diagram illustrating a configuration of a CPU core model unit of a simulation apparatus according to a third embodiment.

FIG. 14 is a diagram illustrating an example of a hardware configuration of the simulation apparatus according to each of the embodiments of the present invention.

### DESCRIPTION OF EMBODIMENTS

Hereinafter, embodiments of the present invention will be described, using the drawings. Note that, in the respective drawings, same or corresponding portions are given the same reference numeral. In the description of the embodiments, explanation of the same or corresponding portions will be omitted or simplified as necessary.

### First Embodiment

A configuration of an apparatus according to this embodiment, operations of the apparatus according to this embodiment, and effects of this embodiment will be sequentially described.

***Description of Configuration***

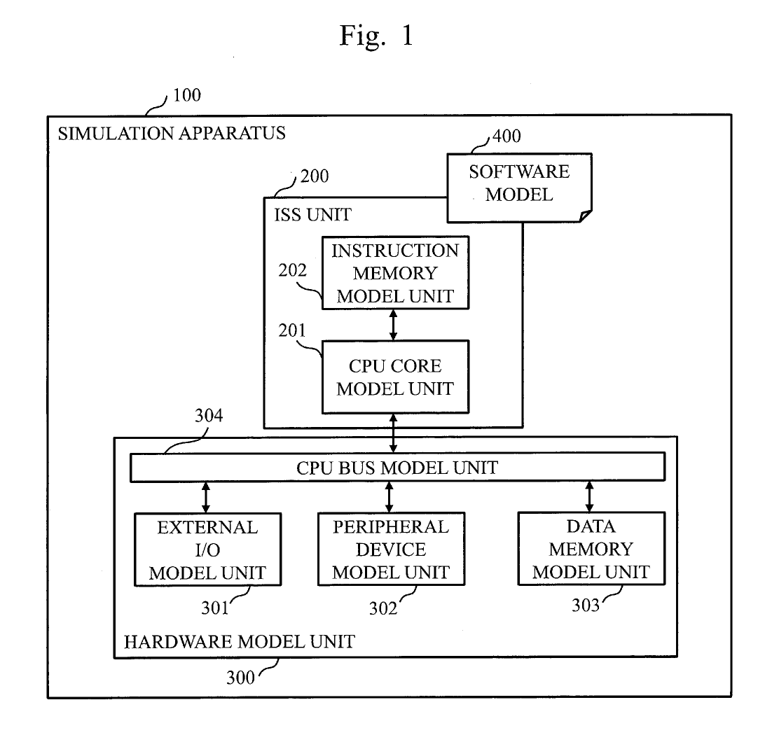

A configuration of a simulation apparatus 100 that is the apparatus according to this embodiment will be described, with reference to FIG. 1.

The simulation apparatus 100 includes an ISS unit 200 and a hardware model unit 300. The simulation apparatus 100 causes a software model 400 to run on the ISS unit 200, thereby simulating an operation of a target system. The target system is a system including various types of hardware. As the hardware of the target system, there are an instruction memory, a data memory, a target CPU including an instruction cache memory and a data cache memory, a bus, an input/output (I/O) interface, and a peripheral device. The instruction memory is a memory to store target codes representing instructions. The instruction cache memory is a cache for storing one or more of the target codes that are loaded from the memory. In the following description, the instruction memory may be just referred to as a “target system memory”, and the instruction cache memory may be just referred to as a “target system cache”.

The software model 400 is software that runs on the target system and is to be verified. That is, the software model 400 is constituted from each target code that can be executed by the target CPU. Therefore, the ISS unit 200 converts the target code to a host code that can be executed by a host CPU and executes the host code, thereby causing the software model 400 to run.

The ISS unit 200 includes a CPU core model unit 201 and an instruction memory model unit 202. The CPU core model unit 201 simulates a function of the target CPU, using a functional model of the target CPU or a target CPU core. The instruction memory model unit 202 simulates a function of the instruction memory of the target system, using a functional model of the instruction memory.

The hardware model unit 300 includes an external I/O model unit 301, a peripheral device model unit 302, a data memory model unit 303, and a CPU bus model unit 304. The external I/O model unit 301 simulates a function of the I/O interface of the target system using a functional model of the I/O interface with an outside of the system. The peripheral device model unit 302 simulates a function of the peripheral device of the target system using a functional model of the peripheral device. The data memory model unit 303 simulates a function of the data memory of the target system, using a functional model of the data memory. The CPU bus model unit 304 simulates a function of the bus of the target system, using a functional model of the bus.

The software model 400 is described, using a high-level language such as a C language. The functional model of each hardware is described, using the high-level language such as the C language or a hardware description language (HDL).

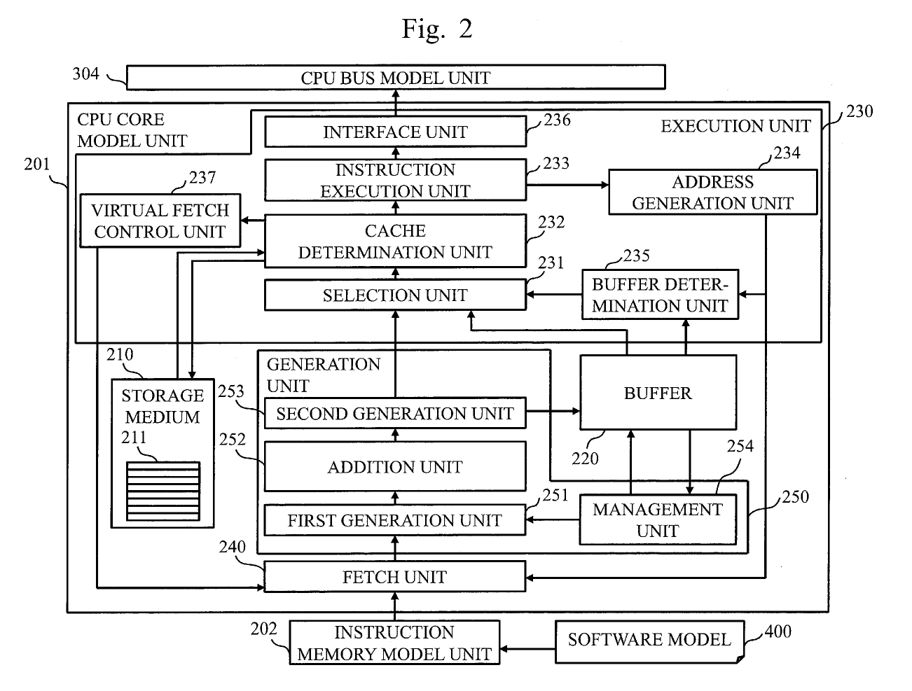

A configuration of the CPU core model unit 201 will be described, with reference to FIG. 2.

The CPU core model unit 201 includes a storage medium 210 and a buffer 220.

The storage medium 210 stores a list of a target code to be stored in the cache of the target system when an operation for a cache miss situation is assumed to be performed by the target system. The “operation for a cache miss situation” is an operation where the target code stored in the memory of the target system is loaded and the cache of the target system is updated by the loaded target code. In this embodiment, the above-mentioned list is stored in the storage medium 210, as a tag table 211. The tag table 211 will be described later, using the drawings.

The buffer 220 is used for storing host codes representing instructions of corresponding codes in a format for simulation. A “corresponding code” is the target code corresponding to one of the host codes, that is, the target code that has been converted to the host code. In this embodiment, the buffer 220 has a larger capacity than the cache of the target system.

The CPU core model unit 201 further includes an execution unit 230, a fetch unit 240, and a generation unit 250.

The execution unit 230 sequentially loads the host codes stored in the buffer 200, using the fetch unit 240. The execution unit 230 executes an instruction of each loaded host code. The execution unit 230 determines whether the corresponding code that is the target code corresponding to each loaded host code is included in the tag table 211. If the execution unit 230 determines that the corresponding code is not included in the tag table 211, the execution unit 230 simulates the operation for a cache miss situation with respect to the corresponding code, using the fetch unit 240. The execution unit 230 updates the tag table 211, according to the simulated operation. In this embodiment, the execution unit 230 includes a selection unit 231, a cache determination unit 232, an instruction execution unit 233, an address generation unit 234, a buffer determination unit 235, an interface unit 236, and a virtual fetch control unit 237. Operations of the respective units will be described later, using the drawings.

When the execution unit 230 subsequently executes an instruction of a host code not stored in the buffer 220, the execution unit 230 simulates the operation for a cache miss situation with respect to a subsequent code that is the target code corresponding to that host code, using the fetch unit 240. The execution unit 230 updates the tag table 211, according to the simulated operation.

When the operation for a cache miss situation is simulated by the execution unit 230 with respect to the target code corresponding to the host code stored in the buffer 220, the generation unit 250 does nothing. On the other hand, when the operation for a cache miss situation is simulated by the execution unit 230 with respect to the subsequent code that is the target code corresponding to the host code not stored in the buffer 220, the generation unit 250 generates a host code corresponding to the subsequent code. The generation unit 250 stores the generated host code in the buffer 220. In this embodiment, the generation unit 250 includes a first generation unit 251, an addition unit 252, a second generation unit 253, and a management unit 254. Operations of the respective units will be described later, using the drawings.

The generation unit 250 adds, to the host code to be generated, a determination code which is a command to determine whether a cache miss of the cache in the target system occurs. When the determination code is added to the loaded host code, the execution unit 230 determines whether the corresponding code is included in the tag table 211. In this embodiment, the generation unit 250 adds the determination code for each instruction. That is, the generation unit 250 adds the determination code every time the target code is converted to the host code.

***Description of Operations***

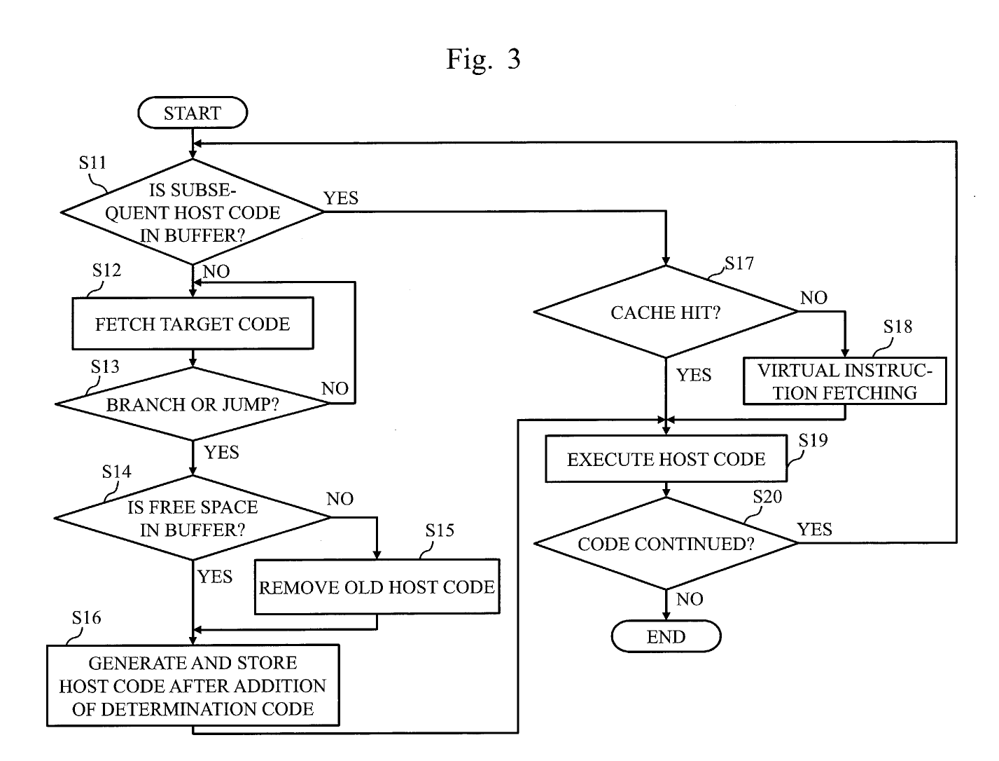

Operations of the simulation apparatus 100 will be described, with reference to FIG. 3. The operations of the simulation apparatus 100 correspond to a simulation method according to this embodiment. The operations of the simulation apparatus 100 correspond to a processing procedure of a simulation program according to this embodiment.

In step S11, the address generation unit 234 generates the address of each target code to be subsequently executed. The address generation unit 234 outputs the generated address to the buffer determination unit 235. The buffer determination unit 235 determines whether or not a host code corresponding to the target code having the address input from the address generation unit 234 is stored in the buffer 220. The buffer determination unit 235 outputs a result of the determination to the selection unit 231. The selection unit 231 selects to cause the fetch unit 240 to fetch the target code to be subsequently executed or to output to the cache determination unit 232 the host code corresponding to the target code to be subsequently executed, based on the result of the determination input from the buffer determination unit 235. If the host code corresponding to the target code to be subsequently executed is not stored in the buffer 220, the flow proceeds to step S12. If the host code corresponding to the target code to be subsequently executed is stored in the buffer 220, the flow proceeds to step S17.

In step S12, the selection unit 231 inputs the address generated in step S11 to the fetch unit 240 from the address generation unit 234. The fetch unit 240 fetches the target code to be subsequently executed, using the address in the instruction memory model unit 202. This simulates an operation for a cache miss situation.

In step S13, the fetch unit 240 determines whether the target code fetched in step S12 is a branch instruction or a jump instruction. If the fetched target code is neither the branch instruction nor the jump instruction, the flow returns to step S12. That is, the fetch unit 240 continues fetching. If the fetched target code is the branch instruction or the jump instruction, the flow proceeds to step S14. That is, the fetch unit 240 stops the fetching.

In step S14, the management unit 254 determines whether or not a space for the host code corresponding to the target code fetched in step S12 is present in the buffer 220. If the space is not present, the flow proceeds to step S15. If the space is present, the flow proceeds to step S16.

In step S15, the management unit 254 removes an old host code from the buffer 220. After step S15, the flow proceeds to step S16.

In step S16, the first generation unit 251 converts, for each instruction, each target code fetched in step S12 to one or more intermediate codes. The addition unit 252 adds a determination code to the one or more intermediate codes corresponding to the instruction of the target code. The second generation unit 253 converts the one or more intermediate codes with the determination code added thereto to a host code, and then stores the host code in the buffer 220. Herein, the one or more “intermediate codes” are codes to be used when the ISS unit 200 disassembles or converts software to processing specific to the ISS unit 200, and are constituted from a group of common instructions such as a store instruction, a load instruction, and an add instruction. After step S16, the flow proceeds to step S19.

In step S17, the selection unit 231 loads, from the buffer 220, the host code corresponding to the target code to be subsequently executed. The selection unit 231 outputs, to the cache determination unit 232, the loaded host code and the address generated in step S11. The cache determination unit 232 executes a determination code included in the host code input from the selection unit 231, thereby determining whether or not a cache hit occurs in the target system. If the cache hit does not occur in the target system, that is, if a cache miss occurs, the flow proceeds to step S18. If the cache hit occurs in the target system, that is, if the cache miss does not occur, the flow proceeds to step S19.

In step S18, the cache determination unit 232 instructs the virtual fetch control unit 237 to perform virtual instruction fetching. The virtual fetch control unit 237 performs the virtual instruction fetching for the instruction memory model unit 202 through the fetch unit 240. The “virtual instruction fetching” is to simulate only the operation for a cache miss situation without generating and storing a host code. That is, in step S18, a process equivalent to S12 is performed, but the processes in step S13 to step S16 are not performed after that process. After step S18, the flow proceeds to step S19.

In step S19, the instruction execution unit 233 executes the host code generated in step S16 or executes a portion other than the determination code of the host code input to the cache determination unit 232 in step S17. The instruction execution unit 233 outputs a result of the execution to the CPU bus model unit 304 through the interface unit 236.

In step S20, the instruction execution unit 233 determines whether or not execution of the software model 400 has been completed. If the execution has not been completed, the flow returns to step S11. If the execution has been completed, the flow is finished.

As mentioned above, if the host code to be subsequently executed is present in the buffer 220 in step S11, that host code is loaded and is then executed in steps S17 to S19. This allows simulation to be executed at high speed.

If the host code to be subsequently executed in the buffer 220 is not present in step S11, the target code is fetched and is converted to the host code in steps S12 to step S16, and that host code is executed in step S19.

In this embodiment, the operation for a cache miss situation is simulated in step S18 as well as step S12. If the operation for a cache miss situation is simulated in S12 alone, the process in step S12 is not executed when a process loop occurs in the buffer 220. That is, the operation for a cache miss situation is not simulated. However, even in a situation where the process loop occurs in the buffer 220, a cache miss may occur in the cache of the target system having a smaller capacity than the buffer 220. In this embodiment, the cache miss is detected in step S17, and the process in step S18 is executed even in such a case. That is, the operation for a cache miss situation is simulated. Accordingly, it becomes possible to perform accurate software performance evaluation.

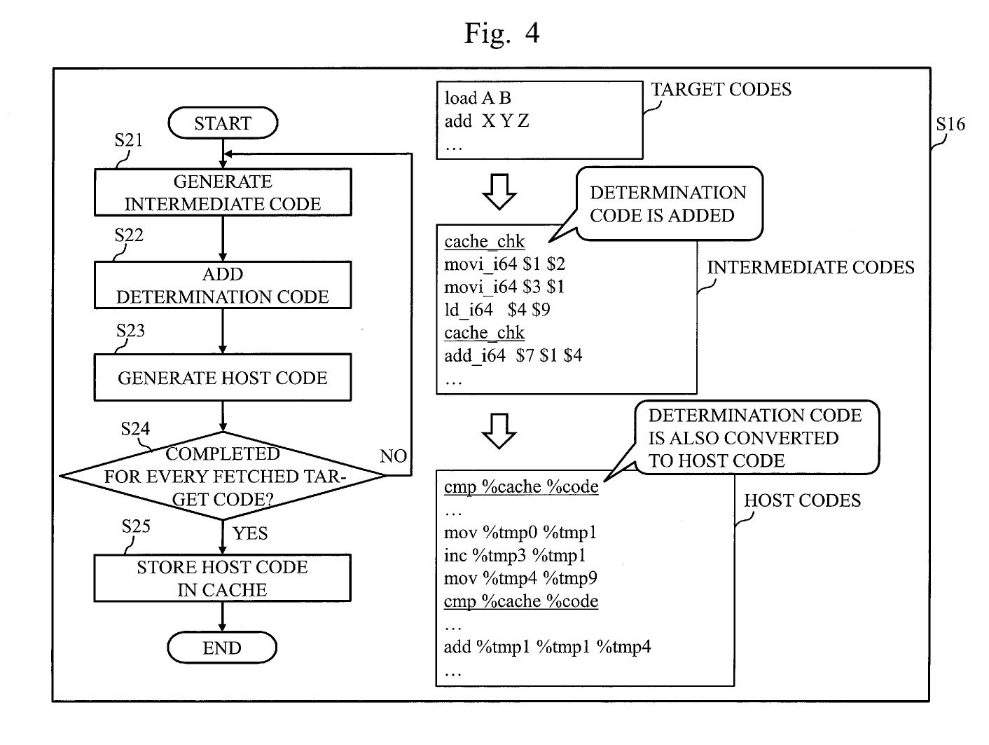

The operation of generating and storing the host code after addition of the determination code by the simulation apparatus 100 will be described, with reference to FIG. 4. This operation corresponds to the process in step S16 in FIG. 3. Though FIG. 4 illustrates an example of code conversion as well as a flow of a series of operations of adding the determination code, this example does not limit description formats and description contents of the target code, each intermediate code, and the host code.

In step S21, the first generation unit 251 converts each target code to the one or more intermediate codes. As described above, the intermediate code is an instruction code specific to the ISS unit 200. Conversion of the target code to the one or more intermediate codes allows instruction codes of various processors to be handled by the ISS unit 200. In the example in FIG. 4, one target code being a load instruction is converted to three intermediate codes that are two movi_i64 instructions and one ld_i64 instruction. The one target code may be converted to an intermediate code constituted from one instruction or a combination of different instructions, according to specifications of the ISS unit 200. The same holds true for another target code being an add instruction.

In step S22, the addition unit 252 adds the determination code to the one or more intermediate codes being an output in step S21. The determination code is implemented as one of instruction codes specific to the ISS unit 200. Though the determination code is described as “cache_chk” in the example in FIG. 4, the “cache_chk” may be changed to an arbitrary name. A portion to which the determination code is added is the beginning of the one or more intermediate codes obtained by the conversion from each target code.

In step S23, the second generation unit 253 converts the one or more intermediate codes to which the determination code is added, which is an output in step S22, to the host code.

In step S24, it is checked whether or not conversion of every target code fetched in step S12 in FIG. 3 to the host code has been completed. If the conversion of every target code has not been completed, the flow returns to step S21, and a subsequent target code is converted to one or more intermediate codes. If the conversion of every target code has been completed, the flow proceeds to step S25.

In step S25, the second generation unit 253 stores, in the buffer 220, the host code generated in step S23.

As mentioned above, in this embodiment, the determination code which is a command to determine a cache hit/miss is added to the one or more intermediate codes rather than the target code. Thus, no particular modification is needed for the software model 400. Accordingly, the software model 400 can be used for software debugging.

Instead of execution of a series of the processes from step S21 to step S23 for one target code and execution of the same series of the processes for a subsequent target code, the processes from step S21 to step S23 may be respectively and sequentially executed for every target code that has been fetched.

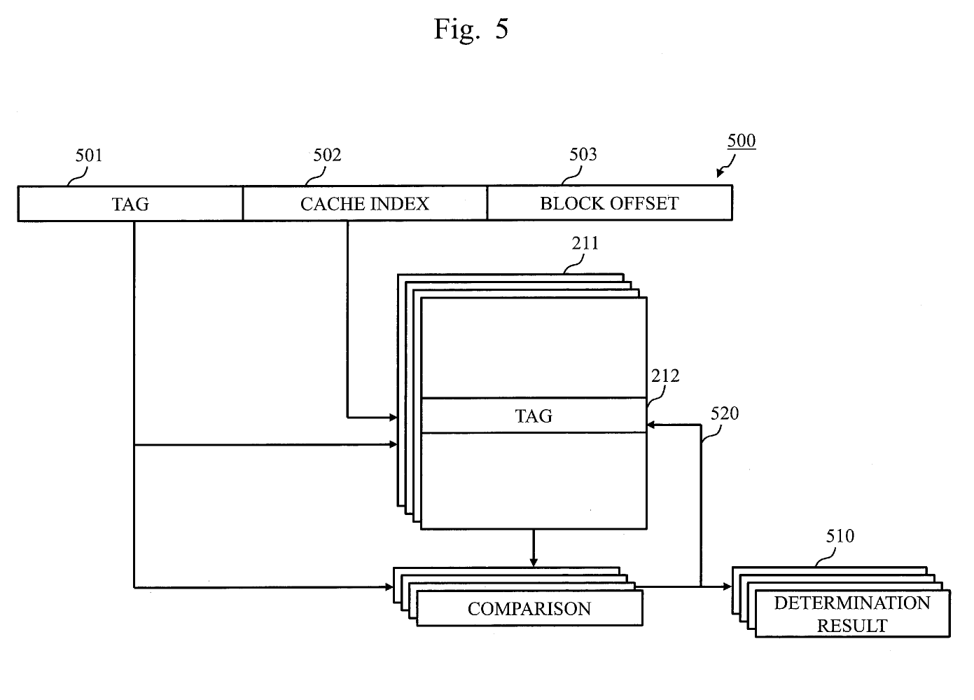

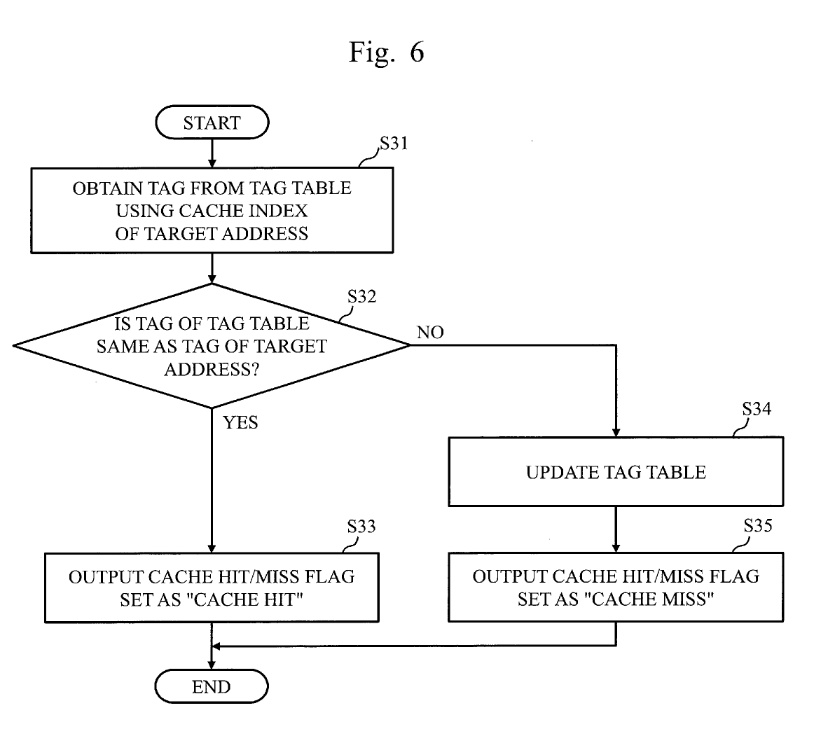

The operation of determining a cache hit/miss by the simulation apparatus 100 will be described with reference to FIGS. 5 and 6. This operation corresponds to the process in step S17 in FIG. 3.

The determination of the cache hit/miss is made by using a target address 500 being the address of the target code and the tag table 211 described above.

The target address 500 is an address itself to be used when the target code is fetched from the memory of the target system. Each target address 500 is divided into a tag 501, a cache index 502, and a block offset 503. The bit width of each of the tag 501 and the cache index 502 is determined by a cache configuration as necessary. When the target address 500 is constituted from 32 bits, it can be set that the tag 501 is constituted from 6 bits, and the cache index 502 is constituted from 9 bits. In this case, 6 bits on the most significant bit (MSB) side of the target address 500 are set to the tag 501, and subsequent 9 bits are set to the cache index 502, and remaining 17 bits are set to the block offset 503.

The tag table 211 stores a tag 212 to identify each target code to be stored in the cache of the target system. If the target code has been stored in the cache of the target system, the tag 501 included at the target address 500 whereby that target code is fetched is stored in the tag table 211, as a new tag 212. A position at which the tag 501 is stored in the tag table 211 is determined by the cache index 502 included at the target address 500 which is the same as that of the tag 501. That is, the cache index 502 indicates an address in the tag table 211, and indicates a location in the tag table 211 where the tag 212 is held. The tag table 211 may store, in addition to the tag 212, information that becomes necessary for software performance evaluation, such as a hit ratio and a frequency of use of the tag 212.

In step S31, the cache determination unit 232 receives an input of the target address 500 from the selection unit 231. The cache determination unit 232 accesses the tag table 211, using the cache index 502 included at the target address 500 that has been input, thereby obtaining the tag 212 from the tag table 211.

In step S32, the cache determination unit 232 compares the tag 212 obtained in step S31 with the tag 501 included at the target address 500 input from the selection unit 231, thereby determining the cache hit/miss. If the tags 212 and 501 are the same, the flow proceeds to step S33. If the tags 212 and 501 are not the same, the flow proceeds to step S34.

In step S33, the cache determination unit 232 outputs the cache hit as a determination result 510 of the cache hit/miss. Specifically, the cache determination unit 232 generates a cache hit/miss flag set as “cache hit”, the cache hit/miss flag indicating the determination result 510. The cache determination unit 232 outputs the generated cache hit/miss flag. The cache hit/miss flag indicates the determination result 510, using one bit. In this embodiment, “1” indicates the “cache hit”, and “0” indicates the “cache miss”.

In step S34, the cache determination unit 232 outputs an update enable flag 520, thereby modifying contents of the tag table 211 obtained by the accessing in step S31 to store the tag 501 included at the target address 500 input from the selection unit 231.

In step S35, the cache determination unit 232 outputs the cache miss, as a determination result 510 of the cache hit/miss. Specifically, the cache determination unit 232 generates a cache hit/miss flag set as “cache miss”, the cache hit/miss flag indicating the determination result 510. The cache determination unit 232 outputs the generated cache hit/miss flag.

In step S12 in FIG. 3 as well, the cache determination unit 232 performs a process equivalent to step S34 upon receipt of an input of the target address 500 from the selection unit 231 and an instruction to update the tag table 211. That is, the cache determination unit 232 outputs the update enable flag 520, thereby modifying contents of the tag table 211 corresponding to the cache index 502 included at the target address 500 input from the selection unit 231 to store the tag 501 included at the target address 500 input from the selection unit 231.

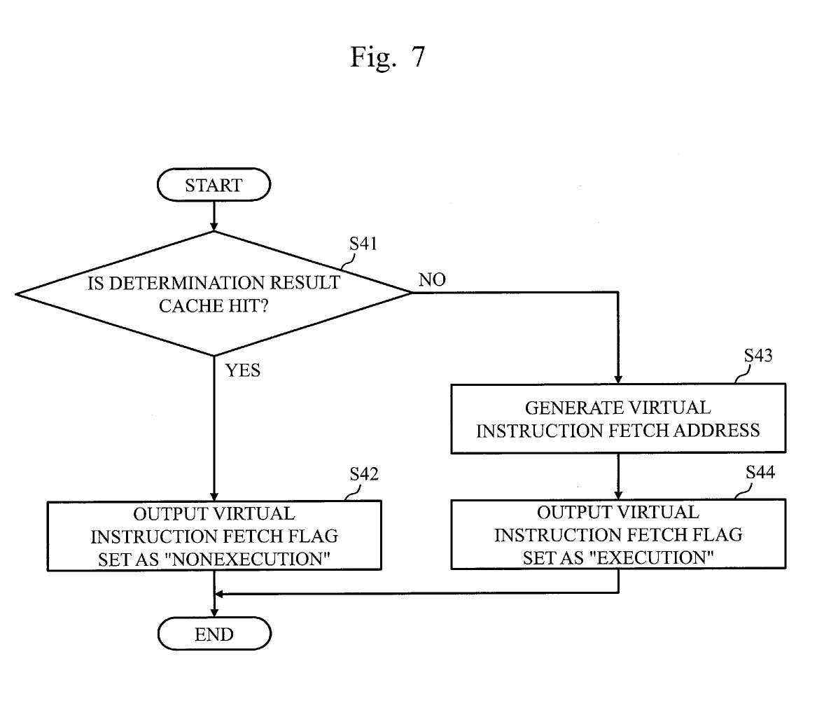

An operation to be performed by the simulation apparatus 100 according to the determination result 510 of the cache hit/miss will be described, with reference to FIG. 7. This operation partially corresponds to the process in step S18 in FIG. 3.

In step S41, the virtual fetch control unit 237 receives the input of the cache hit/miss flag from the cache determination unit 232. The virtual fetch control unit 237 determines whether or not the determination result 510 of the cache hit/miss indicated by the input cache hit/miss flag is the cache hit. If the determination result 510 is the cache hit, the flow proceeds to step S42. If the determination result 510 is the cache miss, the flow proceeds to step S43.

In step S42, the virtual fetch control unit 237 generates a virtual instruction flag set as “nonexecution”. The virtual fetch control unit 237 outputs the generated virtual instruction fetch flag. The virtual instruction fetch flag indicates whether to execute the virtual instruction fetching based on 1 bit. In this embodiment, “1” indicates “execution” and “0” indicates “nonexecution”.

In step S43, the virtual fetch control unit 237 generates a virtual instruction fetch address. The virtual instruction fetch address is an address that is the same as the target address 500 or an address obtained by forming the target address 500 to match the cache line size of the target system.

In step S44, the virtual fetch control unit 237 generates a virtual instruction fetch flag set as “execution”. The virtual fetch control unit 237 outputs the generated virtual instruction fetch flag.

The virtual instruction fetch flag is input to the fetch unit 240. If the virtual instruction fetch address indicates “execution”, the fetch unit 240 fetches the target code from the instruction memory model unit 202, using the virtual instruction fetch address generated in step S43. The fetch unit 240 may discard the fetched target code or may hold the fetched target code in a register for virtual instruction fetching for a certain period of time.

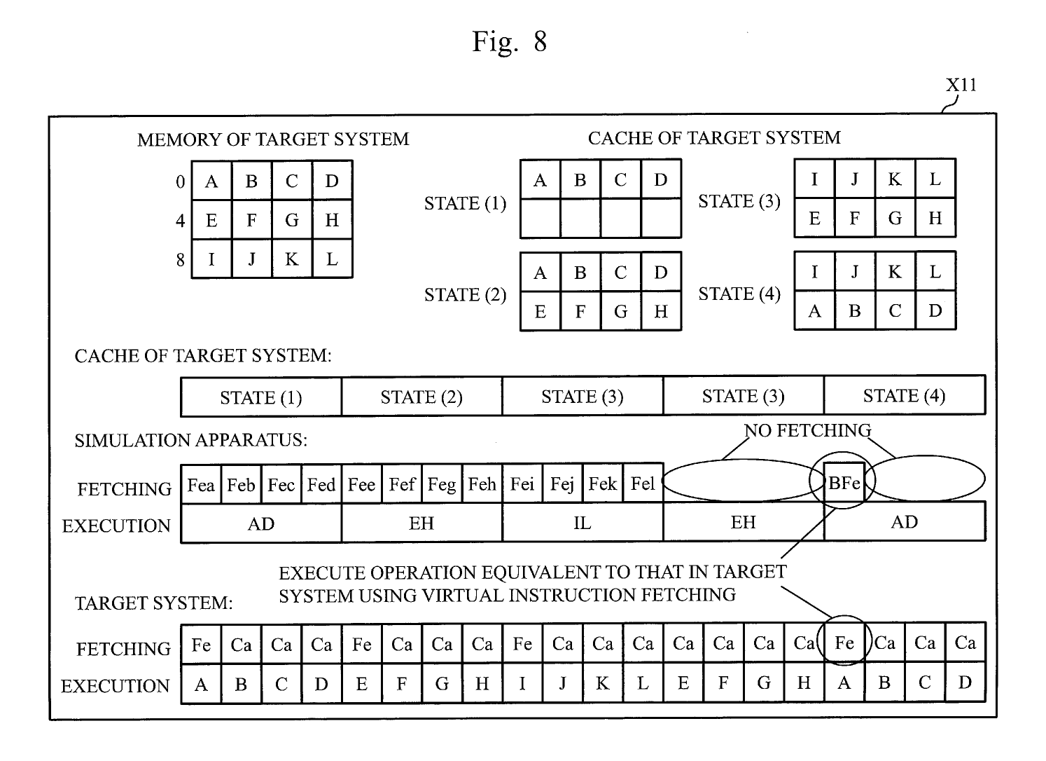

An example X11 of simulation by the simulation apparatus 100 will be described, with reference to FIG. 8.

In the example X11, software constituted from 12 instructions A to L runs on a target system including a two-line cache memory. After the instructions A to L are sequentially executed, the instructions E to H and the instructions A to D are sequentially executed. If there is a free line in the cache of the target system, each instructions is stored in that line. If all the lines are occupied, the instruction is overwritten to an old instruction for update. The buffer 220 of the simulation apparatus 100 includes a sufficient capacity regardless of specifications of the target system.

The upper stage of FIG. 8 illustrates disposition of the instructions in the memory of the target system, and an instruction storage status in each of states (1) to (4) of the cache in the target system. The lower stage in FIG. 8 illustrates a lapse of time from the left to the right, and also illustrates a state of the cache in the target system at each point of time, the instructions that are fetched and executed by the simulation apparatus 100, and the instructions that are fetched and executed by the target system being an actual system. In the drawing, A to L indicate the instructions, Fe indicates fetching, Fex indicates fetching of an instruction X, Ca indicates an access to the cache of the target system, and BFe indicates virtual instruction fetching. AD indicates a host code of the instructions A to D, EH indicates a host code of the instructions E to H, and IL indicates a host code of the instructions I to L. It is assumed that the simulation apparatus 100 performs fetching of each instruction, while the target system performs fetching of every four instructions. In a common system, each instruction is constituted from one byte, and instructions corresponding to 4 bytes are stored in one memory address. Thus, the assumption as mentioned above is made.

Each state of the cache in the target system is managed by the tag table 211 in the simulation apparatus 100.

First, the instructions A to D are executed. A cache miss occurs in each of the simulation apparatus 100 and the target system, so that the instructions A to D are fetched. A first line of two lines of the cache in the target system is filled with the instructions A to D. This brings the cache of the target system into the state (1). The instructions A to D are not stored in the buffer 220 of the simulation apparatus 100 either. Accordingly, the instructions A to D are collectively converted to the host code, and the host code is stored in the buffer 220.

Subsequently, the instructions E to H are executed. A cache miss occurs in each of the simulation apparatus 100 and the target system, and the instructions E to H are fetched. A second line of the two lines of the cache in the target system, which is free, is filled with the instructions E to H. This brings the cache of the target system into the state (2). The instructions E to H are not stored in the buffer 220 of the simulation apparatus 100, either. Accordingly, the instructions E to H are collectively converted to the host code, and the host code is stored in the buffer 220. The host codes of the instructions A to D and the instructions E to H are stored in the buffer 220 at this point of time.

Then, the instructions I to L are executed. A cache miss occurs in each of the simulation apparatus 100 and the target system, and the instructions I to L are fetched. Since both of the two lines of the cache in the target system are filled, the instructions A to D that are old are overwritten and updated by the instructions I to L. This brings the cache of the target system into the state (3). The instructions I to L are not stored in the buffer 220 of the simulation apparatus 100, either. Accordingly, the instructions I to L are collectively converted to the host code, and the host code is stored in the buffer 220. The host codes of the instructions A to D, the instructions E to H, and the instructions I to L are stored in the buffer 220 at this point of time.

Subsequently, the instructions E to H are executed again. A cache hit occurs in each of the simulation apparatus 100 and the target system. Therefore, the instructions E to H are not fetched, and are obtained by a cache access. The instructions E to H are stored in the buffer 220 of the simulation apparatus 100 as well. Accordingly, the host code of the instructions E to H is obtained from the buffer 220 in the simulation apparatus 100.

Then, the instructions A to D are executed again. A cache miss occurs in each of the simulation apparatus 100 and the target system, so that the instructions A to D are fetched. Since both of the two lines of the cache of the target system are filled, the instructions E to H that are old are overwritten and updated by the instructions A to D. This brings the cache of the target system into the state (4). The instructions A to D are stored in the buffer 220 of the simulation apparatus 100. Accordingly, the host code of the instructions A to D is obtained from the buffer 220 in the simulation apparatus 100. That is, the operation of fetching the instructions A to D in the simulation apparatus 100 is performed as virtual instruction fetching.

Thereafter, in a situation where a cache miss occurs even if a host code is stored in the buffer 220, virtual instruction fetching is performed in the simulation apparatus 100 in a similar way. This makes a memory access operation equivalent to that in the actual system to be simulated.

***Description of Effects***

In this embodiment, presence or absence of a cache miss is not determined by using the buffer 220 for storing the host codes. The presence or the absence of the cache miss is determined by managing the list of the target code to be stored in the cache of the target system and by using this list. Consequently, according to this embodiment, accuracy of determination of the cache miss during simulation is improved.

In this embodiment, cooperative simulation between the hardware and the software may be executed without modifying the software, while allowing the simulation to be executing at high speed by using the buffer 220. In this cooperative simulation, a determination of a cache hit/miss in the target system and an instruction memory access operation at a time of occurrence of the cache miss may be simulated. Use of the simulation apparatus 100 according to this embodiment allows the accurate software performance evaluation to be performed.

***Another Configuration***

The list of the target code to be stored in the cache of the target system is managed as the tag table 211 to store each tag 212, in this embodiment. The list of the target code, however, may be managed as a table or another data structure to store different information whereby each target code can be identified.

### Second Embodiment

A configuration of an apparatus according to this embodiment, operations of the apparatus according to this embodiment, and effects of this embodiment will be sequentially described. Mainly a difference from the first embodiment will be described.

***Description of Configuration***

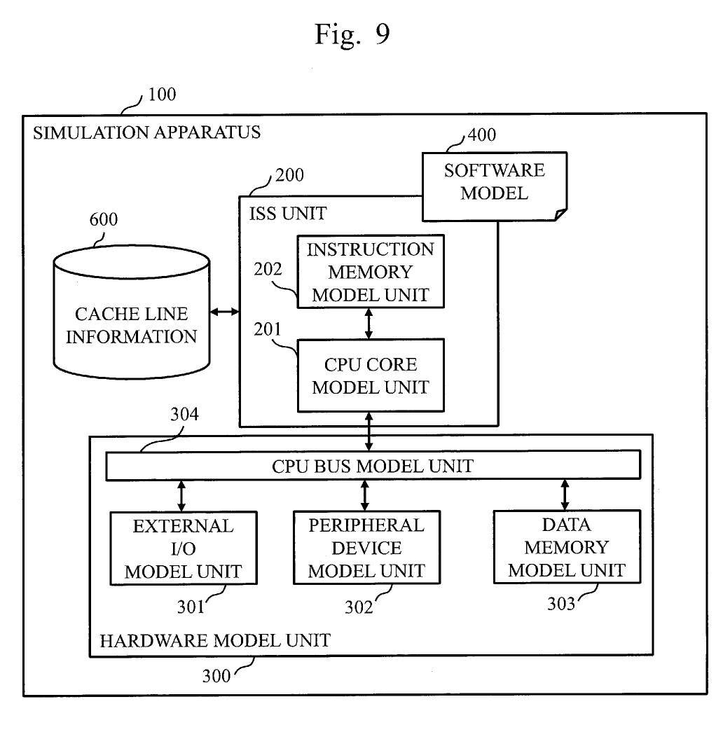

A configuration of a simulation apparatus 100 that is the apparatus according to this embodiment will be described, with reference to FIG. 9.

In this embodiment, the simulation apparatus 100 holds cache line information 600. The other portions are the same as those in the first embodiment illustrated in FIG. 1.

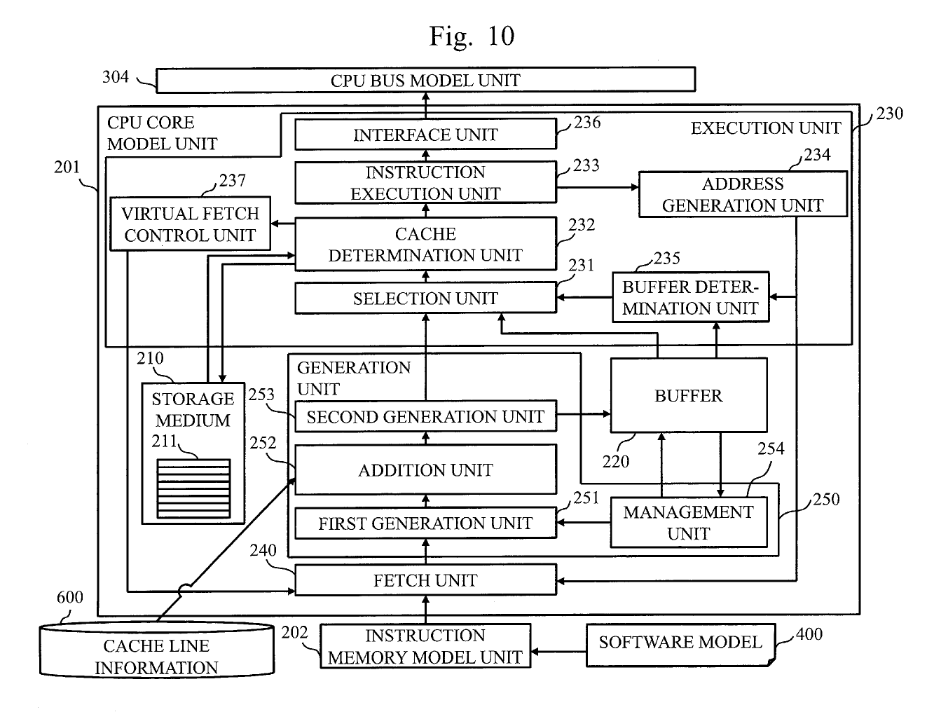

A configuration of a CPU core model unit 201 will be described with reference to FIG. 10.

In the first embodiment, the generation unit 250 adds a determination code for each instruction. On the other hand, in this embodiment, a generation unit 250 adds a determination code for each group of instructions, the number of which corresponds to the line size of a cache of a target system.

In this embodiment, the cache line information 600 is supplied to an addition unit 252. The other portions are the same as those in the first embodiment illustrated in FIG. 2.

***Description of Operations***

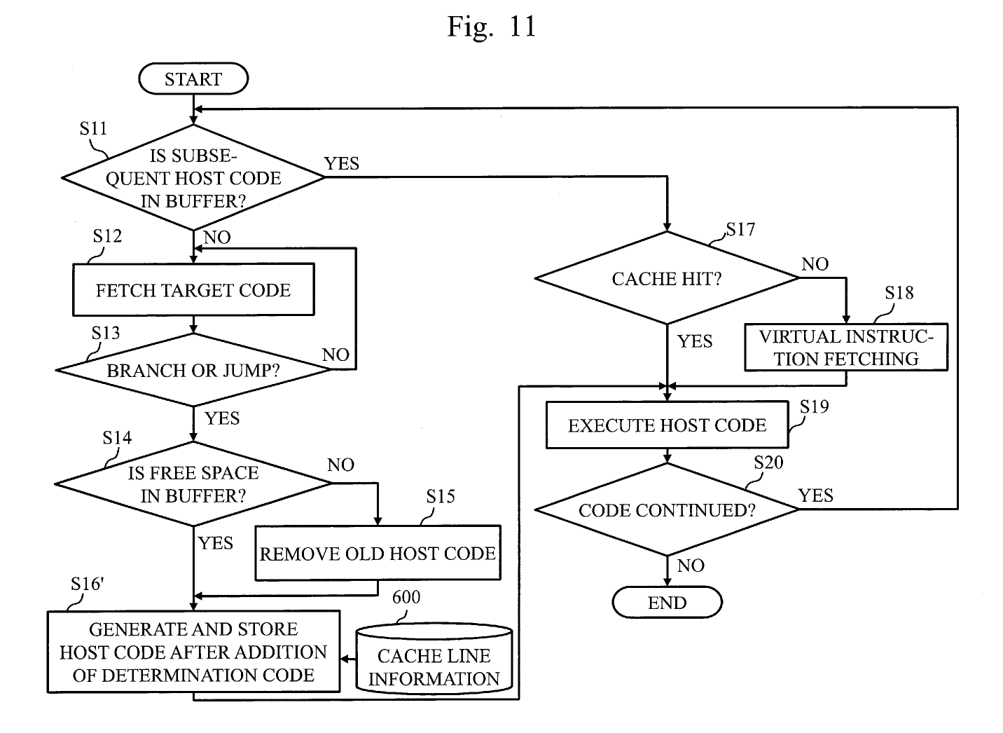

Operations of the simulation apparatus 100 will be described, with reference to FIG. 11. The operations of the simulation apparatus 100 correspond to a simulation method according to this embodiment. The operations of the simulation apparatus 100 correspond to a processing procedure of a simulation program according to this embodiment.

Processes in step S11 to step S15 and processes in step S17 to step S20 are the same as those in the first embodiment illustrated in FIG. 3. In this embodiment, a process in step S16′ is executed in place of step S16. In step S16′, the cache line information 600 is supplied.

In step S16′, a first generation unit 251 converts each target code fetched in step S12 to one or more intermediate codes, for each instruction. The addition unit 252 adds a determination code to the one or more intermediate codes associated with the instructions corresponding to a cache line. A second generation unit 253 converts the one or more intermediate codes to which the determination code has been added to a host code, and stores the host code in a buffer 220.

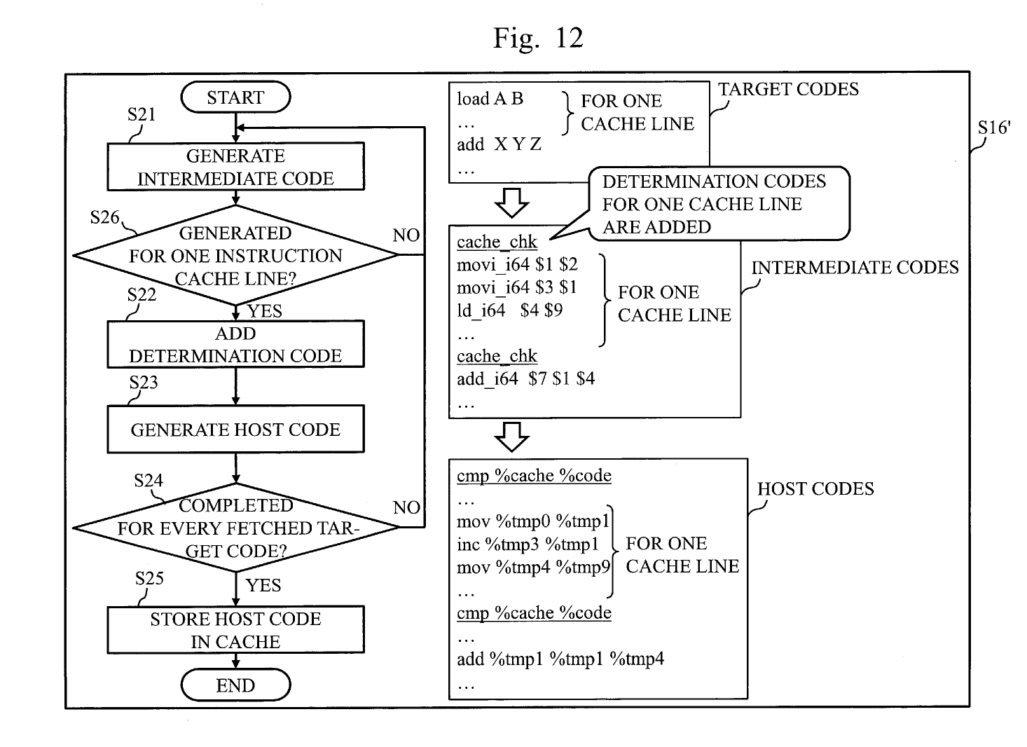

The operation of generating and storing the host code by the simulation apparatus 100 after the simulation apparatus 100 adds the determination code will be described, with reference to FIG. 12. This operation corresponds to the process in step S16′ in FIG. 11. Though FIG. 12 illustrates an example of code conversion as well as a flow of a series of operations of adding the determination code, like FIG. 4, this example does not limit description formats and description contents of the target code, each intermediate code, and the host code.

In step S21, the first generation unit 251 converts the target code to the one or more intermediate codes. After step S21, the flow proceeds to step S26.

In step S26, the addition unit 252 determines whether or not the process in step S21 corresponding to the cache line indicated by the cache line information 600 has been executed. If the process in step S21 corresponding to the cache line has not been executed, the flow returns to step S21, and a subsequent target code is converted to one or more intermediate codes. If the process in step S21 corresponding to the cache line has been executed, the flow proceeds to step S22.

In step S22, the addition unit 252 adds the determination code to the one or more intermediate codes corresponding to the cache line, which is an output in step S21.

Processes from step S23 to step S25 are the same as those in the first embodiment illustrated in FIG. 4.

In this embodiment as well, simulation which is the same as that in the example X11 illustrated in FIG. 8 may be performed.

***Description of Effects***

In this embodiment, cooperative simulation between hardware and software may be executed without modifying the software, while allowing the simulation to be executing at high speed by using the buffer 220. In this cooperative simulation, a determination of a cache hit/miss in the target system and an instruction memory access operation at a time of occurrence of the cache miss may be simulated, for each cache line. Use of the simulation apparatus 100 according to this embodiment allows accurate software performance evaluation to be performed.

### Third Embodiment

With respect to this embodiment, mainly a difference from the first embodiment will be described.

A configuration of a simulation apparatus 100 according to this embodiment is the same as that in the first embodiment illustrated in FIG. 1.

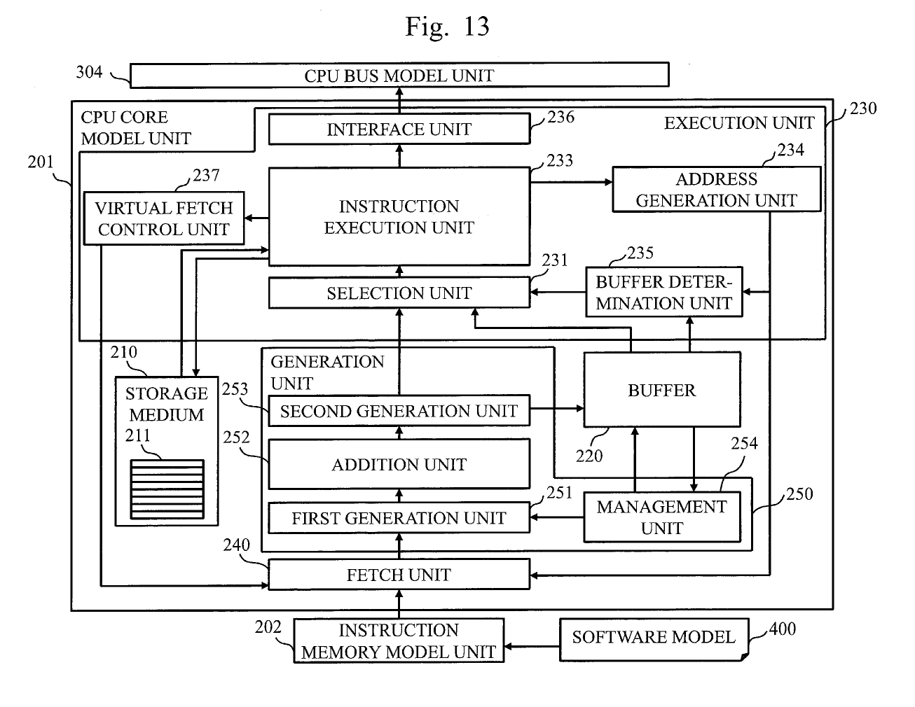

A configuration of a CPU core model unit 201 will be described, with reference to FIG. 13.

In this embodiment, an execution unit 230 does not include a cache determination unit 232. The process that is performed by the cache determination unit 232 in the first embodiment is performed by an instruction execution unit 233.

A determination whether or not a cache hit of a cache in a target system has occurred is made by the instruction execution unit 233. A method of the determination may be the same as that in the first embodiment or the second embodiment, or may be a different method. A determination result 510 indicating whether or not the cache hit has occurred is transmitted from the instruction execution unit 233 to a virtual fetch control unit 237. If the determination result 510 is the cache miss, the virtual fetch control unit 237 performs virtual instruction fetching.

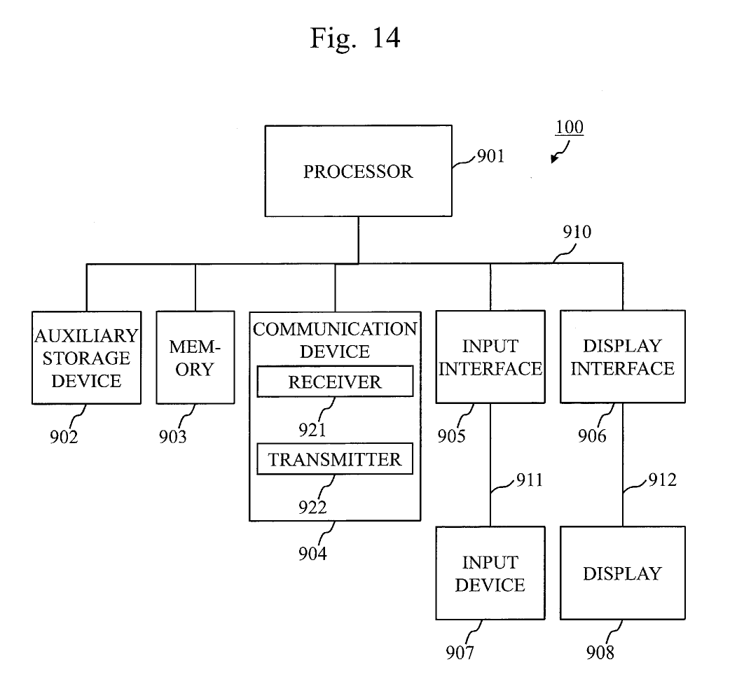

Hereinafter, an example of a hardware configuration of the simulation apparatus 100 according to each embodiment of the present invention will be described with reference to FIG. 14.

The simulation apparatus 100 is a computer. The simulation apparatus 100 includes hardware devices such as a processor 901, an auxiliary storage device 902, a memory 903, a communication device 904, an input interface 905, and a display interface 906. The processor 901 is connected to the other hardware devices via a signal line 910, and controls the other hardware devices. The input interface 905 is connected to an input device 907. The display interface 906 is connected to a display 908.

The processor 901 is an integrated circuit (IC) to perform processing. The processor 901 corresponds to the host CPU.

The auxiliary storage device 902 is a read only memory (ROM), a flash memory, or a hard disk drive (HDD), for example.

The memory 903 is a random access memory (RAM) to be used as a work area of the processor 901 or the like, for example. The memory 903 corresponds to the storage medium 210 and the buffer 220.

The communication device 904 includes a receiver 921 to receive data and a transmitter 922 to transmit data. The communication device 904 is a communication chip or a network interface card (NIC), for example. The communication device 904 is connected to a network, and is used for controlling the simulation apparatus 100 via the network.

The input interface 905 is a port to which a cable 911 of the input device 907 is connected. The input interface 905 is a universal serial bus (USB) terminal, for example.

The display interface 906 is a port to which a cable 912 of the display 908 is connected. The display interface 906 is a USB terminal or a high definition multimedia interface (HDMI (registered trademark)) terminal, for example.

The input device 907 is a mouse, a stylus, a keyboard, or a touch panel, for example.

The display 908 is a liquid crystal display (LCD), for example.

A program to implement functions of “units” such as the execution unit 230, the fetch unit 240, and the generation unit 250 is stored in the auxiliary storage device 902 that is a storage medium. This program is loaded into the memory 903, read into the processor 901, and executed by the processor 901. An operating system (OS) is also stored in the auxiliary storage device 902. At least part of the OS is loaded into the memory 903, and the processor 901 executes the program to implement the functions of the “units” while executing the OS.

Though FIG. 14 illustrates one processor 901, the simulation apparatus 100 may include a plurality of processors 901. Then, the plurality of processors 901 may cooperate and execute programs to implement the functions of the “units”.

Information, data, signal values, and variable values indicating results of processes executed by the “units” are stored in the auxiliary storage device 902, the memory 903, or a register or a cache memory in the processor 901.

The “units” may be provided as “circuitry”. Alternatively, a “unit” may be read as a “circuit”, a “step”, a “procedure”, or a “process”. The “circuit” and the “circuitry” are each a concept including not only the processor 901 but also a processing circuit of a different type such as a logic IC, a gate array (GA), an application specific integrated circuit (ASIC), or a field-programmable gate array (FPGA).

The embodiments of the present invention have been described above; some of these embodiments may be combined to be carried out. Alternatively, any one or some of these embodiments may be partially carried out. Only one of the “units” described in the descriptions of these embodiments may be adopted, or an arbitrary combination of some of the “units” may be adopted, for example. The present invention is not limited to these embodiments, and various modifications are possible as necessary.

### REFERENCE SIGNS LIST

100: simulation apparatus; 200: ISS unit; 201: CPU core model unit; 202: instruction memory model unit; 210: storage medium; 211: tag table; 212: tag; 220: buffer; 230: execution unit; 231: selection unit; 232: cache determination unit; 233: instruction execution unit; 234: address generation unit; 235: buffer determination unit; 236: interface unit; 237: virtual fetch control unit; 240: fetch unit; 250: generation unit; 251: first generation unit; 252: addition unit; 253: second generation unit; 254: management unit; 300: hardware model unit; 301: external I/O model unit; 302: peripheral device model unit; 303: data memory model unit; 304: CPU bus model unit; 400: software model; 500: target address; 501: tag; 502: cache index; 503: block offset; 510: determination result; 520: update enable flag; 600: cache line information; 901: processor; 902: auxiliary storage device; 903: memory; 904: communication device; 905: input interface; 906: display interface; 907: input device; 908: display; 910: signal line; 911: cable; 912: cable; 921: receiver; 922: transmitter

1-9. (canceled)

10. A simulation apparatus to simulate an operation of a system including a memory to store target codes representing instructions and a cache for storing one or more of the target codes that are loaded from the memory, the simulation apparatus comprising:
a storage medium to store a list of a target code to be stored in the cache when an operation for a cache miss situation is assumed to be performed by the system, the operation for a cache miss situation being an operation where the target code stored in the memory is loaded and the cache is updated by the loaded target code;
a buffer for storing host codes representing instructions of corresponding target codes in a format for simulation; and
processing circuitry to sequentially load the host codes stored in the buffer, to execute an instruction of each loaded host code and determine whether a corresponding code being a target code corresponding to each loaded host code is included in the list, and, when determining that the corresponding code is not included in the list, to simulate the operation for a cache miss situation with respect to the corresponding code and update the list according to the simulated operation.

11. The simulation apparatus according to claim 10,
wherein when the processing circuitry subsequently executes an instruction of a host code not stored in the buffer, the processing circuitry simulates the operation for a cache miss situation with respect to a subsequent code being the target code corresponding to the host code, and updates the list according to the simulated operation, and
wherein the processing circuitry generates a host code corresponding to the subsequent code and store the generated host code in the buffer when the operation for a cache miss situation with respect to the subsequent code is simulated.

12. The simulation apparatus according to claim 12,
wherein the processing circuitry adds, to the host code to be generated, a determination code which is a command to determine whether a cache miss of the cache occurs, and
wherein when the determination code is added to a loaded host code, the processing circuitry determines whether the corresponding code is included in the list.

13. The simulation apparatus according to claim 12,
wherein the processing circuitry adds the determination code for each instruction.

14. The simulation apparatus according to claim 12,
wherein the processing circuitry adds the determination code for each group of instructions, a number of which corresponds to a line size of the cache.

15. The simulation apparatus according to claim 10,
wherein the buffer has a larger capacity than the cache.

16. The simulation apparatus according to claim 10,
wherein the list is stored in the storage medium as a tag table that stores a tag to identify each target code to be stored in the cache.

17. A simulation method of simulating an operation of a system including a memory to store target codes representing instructions and a cache for storing one or more of the target codes that are loaded from the memory, the simulation method comprising, by a computer including:
a storage medium to store a list of a target code to be stored in the cache when an operation for a cache miss situation is assumed to be performed by the system, the operation for a cache miss situation being an operation where the target code stored in the memory is loaded and the cache is updated by the loaded target code; and
a buffer for storing host codes representing instructions of corresponding target codes in a format for simulation,
sequentially loading the host codes stored in the buffer, executing an instruction of each loaded host code and determining whether a corresponding code being a target code corresponding to each loaded host code is included in the list, and, when determining that the corresponding code is not included in the list, simulating the operation for a cache miss situation with respect to the corresponding code and updating the list according to the simulated operation.

18. A non-transitory computer readable medium storing a simulation program to simulate an operation of a system including a memory to store target codes representing instructions and a cache for storing one or more of the target codes that are loaded from the memory, the simulation program causing a computer including:
a storage medium to store a list of a target code to be stored in the cache when an operation for a cache miss situation is assumed to be performed by the system, the operation for a cache miss situation being an operation where the target code stored in the memory is loaded and the cache is updated by the loaded target code; and
a buffer for storing host codes representing instructions of corresponding target codes in a format for simulation,
to execute a process of sequentially loading the host codes stored in the buffer, executing an instruction of each loaded host code and determining whether a corresponding code being a target code corresponding to each loaded host code is included in the list, and, when determining that the corresponding code is not included in the list, simulating the operation for a cache miss situation with respect to the corresponding code and updating the list according to the simulated operation.
